(19) United States
(12) Patent Application Publication
(10) Pub. No.: US 2007/0269290 A1
(43) Pub. Date: Nov. 22, 2007

(54) Housing structure with protecting pad

(76) Inventor: Tsong-Yuan Chang, Taipei City (TW)

Correspondence Address: HARNESS, DICKEY & PIERCE, P.L.C., P.O. BOX 8910, RESTON, VA, 20195, US

(21) Appl. No.: 11/434,183

(22) Filed: May 16, 2006

(51) Int. Cl. F16B 37/14

(52) U.S. Cl. 411/548

(57) ABSTRACT

A housing structure with a protecting pad is provided, which comprises a housing body with at least one screw hole, wherein an assembling hole and a slot are respectively provided adjacent to both sides of the screw hole; and an elastic protecting pad, further including a holding lever with a snap ring, wherein the holding lever sleeves into the assembling hole in a rotatable manner and is snapped therein. The protecting pad includes a bump on the other side opposing to the holding lever, and the bump can be inserted into the slot, so that the protecting pad is covered over the screw hole. The protecting pad and the housing are cooperatively disposed, and both can be movably connected and are difficult to be shifted and detached, such that it is convenient and reliable for use.

### BACKGROUND OF THE INVENTION

1. Field of Invention

The present invention relates to a housing structure with a protecting pad, and more particularly, to a housing structure with a protecting pad, which is adhesive-free and is convenient and safe for detachment.

2. Related Art

For products such as electronic products positioned on a desk or on the floor, an elastic foot pad is usually stuck to the screw hole on the bottom cover, to enable the product to seize the desk, to raise the main body higher, and to protect the bottom cover. Such an elastic foot pad is usually bigger than the screw hole and easily covers the screw hole.

The elastic foot pad stuck on the screw hole under the bottom cover of the electronic product is usually made from rubber, coated with an adhesive material on the side that contacts the bottom cover, so as to stick to the screw hole of the bottom cover. When the bottom cover of the electronic product is detached, the elastic foot pad can be opened first and then the screw within the screw hole can be detached. The detaching process is simple and convenient.

However, as for the elastic foot pad adhesively fixed on the bottom cover, the adhesive will become aged after a long time and the foot pad easily shifts, such that the screw hole is exposed. And due to the smaller adhesive area the foot pad easily drops off. When the foot pad is uncovered for repairing the product, its adhesiveness will be affected when being stuck again, and it easily drops off, such that reliability is reduced.

Therefore, an elastic foot pad that can be easily detached and will not drop off after long-time use is desirable.

### SUMMARY OF THE INVENTION

In view of the above problems, a main object of the present invention is to provide a housing structure with a protecting pad which is adhesive-free and is convenient and safe for detachment.

Therefore, a housing structure with a protecting pad is provided by the present invention, which includes a housing body with at least one screw hole, wherein an assembling hole and a slot are respectively provided adjacent to both sides of the screw hole; and an elastic protecting pad, further including a holding lever with a snap ring, wherein the holding lever sleeves into the assembling hole in a rotatable manner and is snapped therein; and including a bump on the other side opposing to the holding lever, which can be inserted into the slot, so that the protecting pad can be covered over the screw hole.

In the housing structure with a protecting pad described in the present invention, the protecting pad and the housing are cooperatively disposed and movably connected. The protecting pad and the housing are fixed by utilizing the elasticity of the protecting pad, such that the protecting pad is not easy to shift and drop off and the product is easy to detach. Furthermore, even frequent detachments will not result in poor reliability of the protecting pad owing to the adhesive holding adopted by the related arts. So it is more convenient and reliable for use.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a structural schematic view of the housing structure with a protecting pad of the present invention, after its bottom cover and top cover are disassembled;

FIG. 2 is a disassembled structural schematic view of the bottom cover and the top cover of the housing structure with a protecting pad of the present invention;

FIG. 3 is a structural schematic view of the bottom cover of the housing structure with a protecting pad of the present invention;

FIG. 4 is a structural schematic view of the elastic foot pad of the housing structure with a protecting pad of the present invention;

FIG. 5 is a flowing chart of the mount of the bottom cover and the top cover of the housing structure with a protecting pad of the present invention;

FIG. 6 is a flowing chart of the detach of the bottom cover and the top cover of the housing structure with a protecting pad of the present invention; and

FIG. 7 is a structural schematic view of the housing structure with a protecting pad of the present invention, after being detached.

### DETAILED DESCRIPTION OF THE INVENTION

Preferred embodiments of the present invention will be described in detail with reference to the drawings.

The housing structure with a protecting pad of the present invention includes a housing and a protecting pad used for covering a screw hole of the housing. The housing described in the embodiments of the present invention is a bottom cover, and the protective pad is usually referred to as a foot pad. Since the screw hole on the bottom cover may be used to connect and fix the bottom cover with a top cover via a fix screw, it is inevitable to involve the top cover in the description of the present invention. A bottom cover with an elastic foot pad of the present invention, combined with the top cover, can be applied in various products, such as electronic products, household goods, etc.

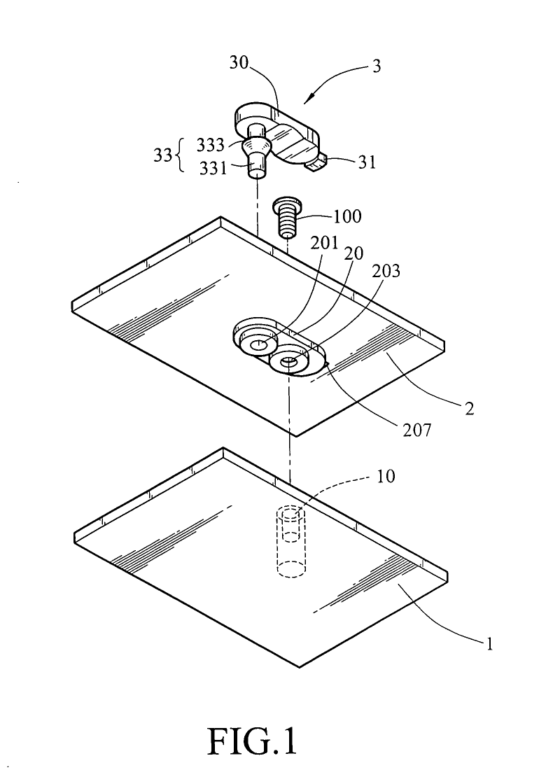

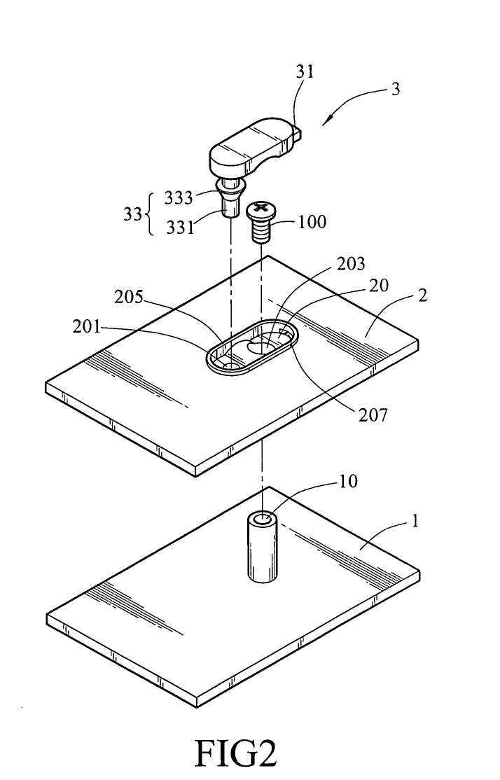

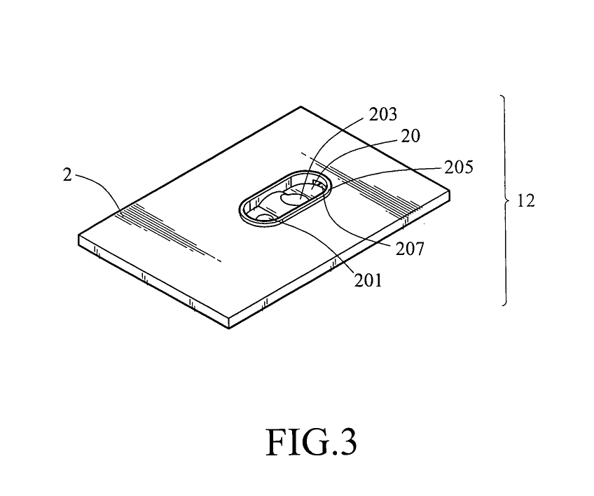

FIGS. 1 and 2 are respectively structural schematic views of a housing structure with a protecting pad, after the elastic foot pad, bottom cover, and top cover are exploded. As shown in FIGS. 1 and 2, the top cover 1 corresponding to the bottom cover 2 comprises a screw hole 10 used for receiving a set screw 100, and the set screw 100 is firmly fixed within the screw hole 10. The bottom cover 2 comprises a foot pad base 12 with a receiver 20 concaved towards the top cover 1. The shape of the receiver 20 is the same as that of the elastic foot pad 3. The receiver 20 further includes a slot 207 and two parallel columnar receiving holes, i.e., the screw hole 201 and the lever-assembling hole 203. The slot 207 is located on the side of the receiver 20 and its shape corresponds to that of the bump 31 (described in detail hereafter) of the elastic foot pad 3. The screw hole 201 and the lever-assembling hole 203 protrude towards the top cover 1 corresponding to the receiver 20. The screw hole 201 used to receive and fix the set screw 100 comprises two coaxial round openings. The diameter of the round opening directing to the top cover 1 equals to that of a screw bolt of the set screw 100, and the diameter of the other opening is large enough to receive the cap portion of the set screw 100, such that the screw hole 201 can snap the set screw 100. The shape of another lever-assembling hole 203 is same as that of the screw hole 201, which is used to receive the holding portion 33 (described below in detail) of the elastic foot pad 3. As shown in FIG. 3, on the side of the foot pad base 12 opposing to the elastic foot pad 3 an annular bump 205 is further included, which just surrounds the receiver 20. By combining the annular bump 205 with the receiver 20, the elastic foot pad 3 can be clipped within the foot pad base 12, to prevent the elastic foot pad 3 from gliding on the bottom cover 2. The annular bump 205 is not a closed ring, with one of its ends being open, such that it is easy for the user to push the elastic foot pad 3 through the open end.

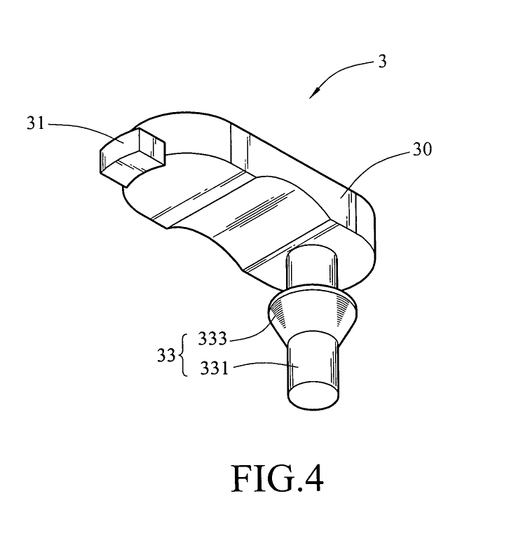

As shown in FIG. 4, the elastic foot pad 3 comprises a main body 30, a bump 31, and a holding portion 33. The elastic foot pad 3 is made of rubber materials, being elastic and formed by integration. The bump 31 is located at the bottom of the side of the elastic foot pad 3; the central part of the main body 30 is concaved inwards as an arc; the holding portion 33 is located at one end of the bottom of the elastic foot pad 3, with the position corresponding to the lever-assembling hole 203 of the receiver 20. The holding portion 33 comprises a columnar holding lever 331 and a snap ring 333 located in the center of the holding lever 331. The diameter of the holding lever 331 is the same as that of a round opening of the lever-assembling hole 203 opposing to the top cover 1. The snap ring 333 is an annular cone with the diameter gradually reducing from one end neighboring the main body 30 until the diameter is same as that of the holding lever 331, and its maximum diameter is greater than that of one opening of the lever-assembling hole 203 towards the direction of the top cover 1.

The receiver 20 is provided with an arced convex surface corresponding to the arc concaved surface of the elastic foot pad 3, so that the receiver 20 and the elastic foot pad 3 will tightly match with each other.

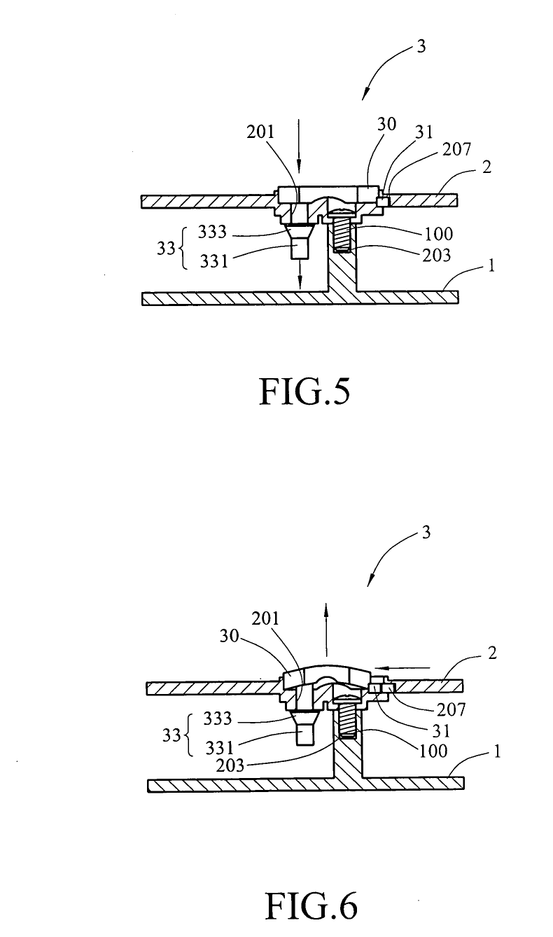

In order to understand the bottom cover with an elastic foot pad of the present invention more clearly, the mounting and detaching process will be further illustrated below. As shown in FIG. 5, it is a structural schematic view after the elastic foot pad, the bottom cover, and the top cover have been mounted together. The mounting process includes the following steps. First, a set screw 100 is inserted into the screw hole 201 of the bottom cover 2, and rotated within the screw hole 10 of the top cover 1 that is aligned with the bottom cover 2 for fixing, so that the top cover 1 and the bottom cover 2 will be connected and fixed. Then, the holding lever 331 of the holding portion 33 of the elastic foot pad 3 is aligned with the lever-assembling hole 203 of the bottom cover 2, and the bump 31 is aligned with the slot 207. Push downwards in the direction as shown by the arrow A in the figure, such that the holding lever 331 is inserted into the lever-assembling hole 203. Then, pull the holding lever 331 in the direction as shown by the arrow B in the figure. Since the elastic foot pad 3 is made from elastic rubber material, and the snap ring 333 is a cone with an increasing diameter, pulling the holding lever 331 can make the snap ring 333 deform (bend towards the main body 30), thereby passing through the lever-assembling hole 203. The snap ring 333 can regain its shape under its elastic effect, such that the bump 31 can be snapped within the slot 207 accordingly. In this way, the snap ring 333 of the elastic foot pad 3 is clipped outside the lever-assembling hole 203, the bump 31 is received in the slot 207, and the main body 30 is received in the foot pad base 12, such that the elastic foot pad 3 and the bottom cover 2 are connected and fixed.

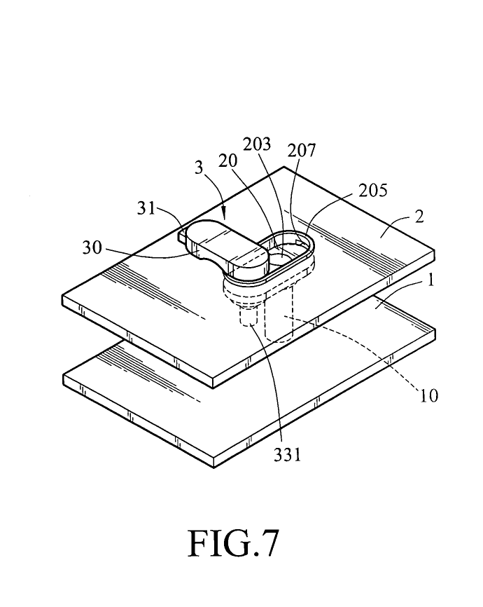

The detaching method of the bottom cover with an elastic foot pad of the present invention can be appreciated with reference to FIGS. 6 and 7. First, as shown in FIG. 6, since the main body 30 of the elastic foot pad 3 has a concaved arc portion and the receiver 20 of the foot pad base 12 has a corresponding arced convex surface, upon pushing the elastic foot pad 3 along the direction of the arrow C by the user, the concaved portion of the main body 30 for the elastic foot pad 3 will essentially form an arch towards the direction shown by the arrow D, such that the bump 31 will disengage from the slot 207, and the main body 30 will disengage from the foot pad base 12. Accordingly, a portion of the elastic foot pad 3 will disengage from the foot pad base 12, but the holding portion 33 of the elastic foot pad 3 is still snapped within the lever-assembling hole 203 of the foot pad base 12. As shown in FIG. 7, the screw hole 201 and the set screw 100 can be exposed by rotating the elastic foot pad 3, so that the set screw 100 can be detached by the user conveniently.

In the bottom cover with an elastic foot pad of the present invention, the foot pad is movably connected with the bottom cover. The foot pad and the bottom cover are fixed with each other by utilizing the elasticity of the foot pad, which both do not easily shift and drop off, but are convenient for detachment, and even frequent detachments will not result in poor reliability owing to the adhesive fixing of the conventional art. Thus, it is more convenient and reliable for use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A housing structure with a protecting pad, comprising:
a housing body, with at least one screw hole, wherein an assembling hole and a slot are respectively provided adjacent to both sides of the screw hole; and
an elastic protecting pad, having a holding lever with a snap ring, wherein the holding lever sleeves onto the assembling hole in a rotatable manner and the snap ring is snapped within the assembling hole; the protective pad has a bump with respect to the other side of the holding lever, which can be inserted into the slot, such that the protecting pad is covered on the screw hole.

2. The housing structure with a protecting pad as claimed in claim 1, wherein the housing body further comprises a concaved pad base, with a shape corresponding to that of the protecting pad, which is used for receiving the protecting pad, and the screw hole and the assembling hole are located in the pad base; the slot is located on a side surface of the pad base.

3. The housing structure with a protecting pad as claimed in claim 2, wherein a concaved arc portion is provided at the center of the bottom surface of the protecting pad, and the pad base has a convex arc surface corresponding to the concaved arc portion.

4. The housing structure with a protecting pad as claimed in claim 2, wherein the pad base further comprises an annular bump for further fixing the protecting pad.

5. The housing structure with a protecting pad as claimed in claim 1, wherein the diameter of the assembling hole is smaller than that of the snap ring.

6. The housing structure with a protecting pad as claimed in claim 5, wherein the snap ring is an annular cone structure, with the diameter of the part neighboring the protecting pad being the maximum diameter, and the diameter of the part away from the protecting pad being the same as that of the holding lever.
